(19) United States
(12) Patent Application Publication
(10) Pub. No.: US 2003/0130750 A1
(43) Pub. Date: Jul. 10, 2003

(54) Controller for controlled variables and control system for the same

(76) Inventor: Hirohumi Hirayama, Tokyo (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/336,027

(22) Filed: Jan. 3, 2003

(30) Foreign Application Priority Data
Jan. 9, 2002 (JP) 2002-2743

(51) Int. Cl. G05B 15/02; G05B 19/18; G05B 13/02; G05B 11/32

(52) U.S. Cl. 700/53; 700/67

(57) ABSTRACT

A PID operating unit inputs a value obtained by subtracting a setting value stored in a setting value memory from a measured value (temperature) of a controlled device and outputs controlled variable information in order to control the controlled device by proportional plus integral plus derivative action. A time-proportioning outputting unit converts this controlled variable information into an ON/OFF signal for switching an ON/OFF state of a switch of a heater in the controlled device in accordance with the controlled variables and feeds the ON/OFF signal to the heater and to an output selecting unit.

### BACKGROUND OF THE INVENTION

1. Field of the Invention

The present invention relates to a controller for controlled variables for controlling devices extensively installed while transmitting and receiving control information, and a control system for the same in the filed of process control, or the like.

2. Description of the Related Art

FIG. 12 is a block diagram showing a configuration of the conventional controller for controlled variables and a control system for the same.

FIG. 12A shows a digital controller for controlled variables and a digital control system for the same. FIG. 12B shows an analog controller for controlled variables and an analog control system for the same.

Referring to FIG. 12A, reference numeral denotes a host computer for mediating control information, 92 denotes a communication line, A1 denotes a controller for transmitting digital control information, A2 to A5 denote controllers for receiving digital control information.

Referring to FIG. 12B, reference numeral 93 denotes an electric wire, B1 denotes a controller for transmitting analog control information, B2 to B6 denote controllers for receiving analog control information.

The operation of the conventional controller for controlled variables will now be described.

In FIG. 12A, a DO (Digital Output) terminal of the controller A1 is connected to a DI (Digital Input) terminal of the controllers A2 to A5 via the communication line 92. The controller A1 transmits control information, represented by controlled variables and inclusive of a setting value for control, to the host computer 91. Usually, this setting value is often identical with that stored in the controller A1 for control of a device that is under the control thereof.

The host computer 91 simultaneously transmits the control information transmitted from the controller A1 to the controllers A2 to A5.

The controllers A2 to A5 receive the control information transmitted from the controller A1 through the host computer 91, extract from this control information controlled variables (setting value) for controlling a device (not shown) that is under the control thereof, and uses this extracted setting value as one for controlling the device that is under the control thereof.

In FIG. 12B, an analog output terminal of the controller Bi is connected to that of the controllers B2 to B5 with an electric wire 93. The controller B1 transmits a control signal, represented by analog voltage values of 0V to 5V and inclusive of a setting value for control, to the analog output terminal of the controller B1 through the electric wire 93.

The controllers B2 to B5 convert the control signal represented by the above voltage values into the setting value in order to use the setting value as one for controlling a controlled device (not shown) that is under the control thereof.

As a related invention, there is a Publication of Patent Application No. 2875677 entitled “temperature instrumentation system”, in which the system specifies an area on time base of a graph drawn by given patterns, inputs a number that specifies the area, a target control value in this area, a present target control value, and temperature of the device to be controlled to a PID (Proportional plus Integral plus Derivative) operating unit so as to control the temperature thereof, as well as transmits the above each control information to another temperature regulator via a digital data transmitting unit.

In the case where the configuration is taken as shown in FIG. 12A, the conventional controller for controlled variables and the control system for the same thus configured as above compels installations of hardware of the host computer 91, and software for reading, writing, and transmitting and receiving the control information. Such a configuration induces rises in price of the installations.

Also, in the case where the configuration is taken as shown in FIG. 2B, it is forced to transmit the setting value represented by analog signal values between the transmitting-side controller B1 and the receiving-side controllers B2 to B5. Such a configuration impedes the enhancement of accuracy of control.

Indeed, the invention disclosed in the Publication of Patent Application No. 2875677 entitled “temperature instrumentation system” merely discloses a path for transmission and reception processing of controlled variables through the PID operating unit, and does not one that converts general control information inclusive of controlled variables, a manipulation method, and various instructions into digital information so as to transmit and receive the converted digital information, unlike the controller for controlled variables and the control system for the same of the present invention.

Further, a transmission and reception processing path of the controlled variables through the PID operating unit lacks addition of a number of input information to be inputted to the PID operating unit at the previous stage, unlike the controller for controlled variables and the control system for the same of the present invention. Moreover, output information from the PID operating unit is far from being converted into ON/OFF information corresponding to the controlled variables through a time-proportioning outputting unit.

### SUMMARY OF THE INVENTION

The present invention has been made to solve the above problems and an object thereof is to provide a controller for controlled variables capable of transmitting and receiving control information, as digital information among the controllers, such as given controlled variables, a manipulation method, various instructions, event notifying information, and controlled variables of process control.

Another object of the present invention is to provide a control system capable of transmitting and receiving control information, as digital information among the controllers, such as given controlled variables, a manipulation method, various instructions, event notifying information, and controlled variables of process control.

A controller for controlled variables for transmitting control information to receiving-side controllers connected to a communication line according to the present invention includes serial signal transmitting means for converting transmission data in an internal form inclusive of control information read out from a memory, and for outputting it to a DO terminal after having produced a transmission signal inclusive of the binary data.

According to the present invention, the controller for controlled variables for transmitting the control information to the receiving-side controllers connected to the communication line includes the serial signal transmitting means for converting the transmission data in an internal form inclusive of the control information read out from the memory, and for outputting the converted signal to the DO terminal after having produced the transmission signal inclusive of the binary data.

This enables transmission of general control information inclusive of the controlled variables to another controller for controlled variables via the communication line.

A controller for controlled variables for receiving control information from a transmitting-side controller connected to a communication line according to the present invention includes serial signal receiving means for converting serial binary data contained in a received signal inputted to a DI terminal into received data in an internal form, and for writing it in a memory.

According to the present invention, the controller for controlled variables for receiving the control information from the transmitting-side controller connected to the communication line includes the serial signal receiving means for converting the serial binary data in an internal form contained in the received data inputted to the DI terminal, and for writing the converted signal in the memory.

This enables reception of general control information inclusive of the controlled variables from another controller for controlled variables via the communication line.

A controller for controlled variables for transmitting control information required when the receiving-side controller controls a controlled device that is under the control thereof to the receiving-side controller connected to a communication line according to the present invention includes output selecting means for selecting and outputting a plurality of output signals by previously established algorithm; measured value controlling means for controlling a measured value of predetermined physical variable obtained by measuring the controlled device that is under the control thereof on the basis of a predetermined setting value; PID operating means for executing an operation for control of the controlled device by proportional plus integral plus derivative action using an output of the measured value controlling means, and for outputting the executed result as a manipulated variable; time-proportioning outputting means for inputting the manipulated variable outputted from the PID operating means, converting it to an ON/OFF signal required when manipulating a switch of the device in the controlled device of the receiving-side controller through the receiving-side controller, outputting the ON/OFF signal as an output signal to the controlled device that is under the control thereof, and to the output selecting means.

According to the present invention, the controller for controlled variables for transmitting control information required when the receiving-side controller controls the controlled device that is under the control thereof to the receiving-side controllers connected to the communication line includes the output selecting means for selecting and outputting a plurality of output signals by previously established algorithm; the measured value controlling means for controlling the measured value of a given physical variable obtained by measuring the controlled device that is under the control thereof on the basis of the predetermined setting value; the PID operating means for executing an operation for controlling the controlled device by proportional plus integral plus derivative action using an output from the measured value controlling means, and for outputting the executed result as a manipulated variable; the time-proportioning outputting means for inputting the manipulated variable outputted from the PID operating means, converting it into an ON/OFF signal required when manipulating the switch of the device in the controlled device through the receiving-side controller, and outputting the ON/OFF signal as an output signal to the controlled device, and to the output selecting means.

This allows transmission of the control information to another controller for controlled variables via the communication line when actually controlling the controlled device that is under the control thereof by proportional plus integral plus derivative action.

A controller for controlled variables for controlling a controlled device that is under the control thereof on the basis of control information of plural systems received from receiving-side controller connected to a communication line according to the present invention includes input selecting means for selecting and outputting the control information of the plural systems; purpose selecting means for distributing the selected control information depending on its purpose; serial data receiving means for converting serial binary data contained in one output from the purpose selecting means or an ON/OFF signal into received data in an internal form, and writing it in a memory.

According to the present invention, the controller for controlled variables for controlling the controlled device on the basis of the control information of the plural systems received from the transmitting-side controller connected to the communication line includes the input selecting means for selecting and outputting the control information of the plural systems; purpose selecting means for distributing the selected control information depending on its purpose; the serial signal receiving means for converting serial binary data contained in one output outputted from the purpose selecting means or the ON/OFF signal into the received data in an internal form, and for writing the converted signal in the memory.

This permits selection of the control signal received through the plural paths on the basis of predetermined configurations, functions, and operations of the output selecting unit, and for outputting the selected control information by given purposes or after applying a conversion thereto, if necessary. Besides, when the serial binary signal or the ON/OFF signal is received, this allows control of the control information contained in these signals by proportional plus integral plus derivative action supposing, as if it were the control information for controlling the controlled device that is under the control thereof.

In a control system for controlled variables including a transmitting-side controller connected to a communication line and a plurality of receiving-side controllers for receiving control information from the transmitting-side controller according to the present invention, the transmitting-side controller includes means for controlling one section of common controlled devices, and for transmitting the control information used for control of the plurality of receiving-side controllers; and each of the plurality of receiving-side controllers including means for controlling each of the common controlled devices in correlation with each of the plurality of receiving-side controllers except the one section on the basis of the control information transmitted from the transmitting-side controller.

According to the present invention, in the control system for controlled variables including the transmitting-side controller connected to the communication line and a plurality of receiving-side controllers for receiving the control information from the transmitting-side controller, the transmitting-side controller includes means for controlling one section of the common controlled device, and for transmitting the control information used for control, and each of the plurality of receiving-side controllers includes means for controlling each of the section of the common controlled devices in correlation with each of the plurality of receiving-side controllers except the one section on the basis of the control information transmitted from the receiving-side controllers.

This enables control of the one section of the common controlled devices by the transmitting-side controller, and remaining corresponding each section except the one section of the common controlled devices by the plurality of receiving-side controllers on the basis of the control information for control.

In a control system for controlled variables including a transmitting-side controller connected to a communication line and a receiving-side controller for receiving control information from the transmitting-side controller according to the present invention, the transmitting-side controller includes means for transmitting a first physical variable obtained by measuring common controlled devices to the receiving-side controller, and the receiving-side controller controls a second physical variable of the common controlled devices on the basis of the first physical variable transmitted from the transmitting side controller.

According to the present invention, in the control system including the transmitting-side controller connected to the communication line and the receiving-side controller for receiving the control information from the transmitting-side controller, the transmitting-side controller includes means for transmitting the first physical variable obtained by measuring the common controlled devices to the receiving-side controller; and the receiving-side controller controls the second physical variable of the common controlled devices on the basis of the first physical variable transmitted from the transmitting-side controller.

This allows control of each of the remaining corresponding sections except the one section of the common controlled device on the basis of the control information for control.

The above and other objects and the attendant advantages of the invention will become readily apparent by referring to the following detailed description when considered in conjunction with the accompanying drawings

### BRIEF DESCRIPTION OF THE DRAWINGS

FIG. 1 is an explanatory drawing showing the principle of the control system for controlled variables of a first embodiment.

FIG. 2 is a block diagram showing a configuration of the transmitting-side controller for controlled variables of the first embodiment and a flow chart showing its operations.

FIG. 3 is a block diagram showing a configuration of the receiving-side controllers for controlled variables of a second embodiment and a flow chart showing its operations.

FIG. 4 is a block diagram showing a configuration of the transmitting-side controller for controlled variables of a third embodiment.

FIG. 5 is a block diagram showing a system configuration in which the controller for controlled variables shown in FIG. 4 is applied to a specific controlled device.

FIG. 6 is a block diagram showing a configuration of the receiving-side controllers for controlled variables of a fourth embodiment.

FIG. 7 is a block diagram showing a system configuration in which the receiving-side controllers for controlled variables shown in FIG. 6 are applied to a specific controlled device.

FIG. 8 is a block diagram showing a system configuration in which the receiving-side controllers for controlled variables shown in FIG. 6 are applied to a specific controlled device.

FIG. 9 is a block diagram showing a configuration of the control system for controlled variables of a fifth embodiment.

FIG. 10 is a block diagram showing a schematic configuration of the control system for controlled variables of a sixth embodiment.

FIG. 11 is a block diagram showing a specific configuration of the control system for controlled variables.

FIG. 12 is a block diagram showing a conventional controller for controlled variables and a control system for the same.

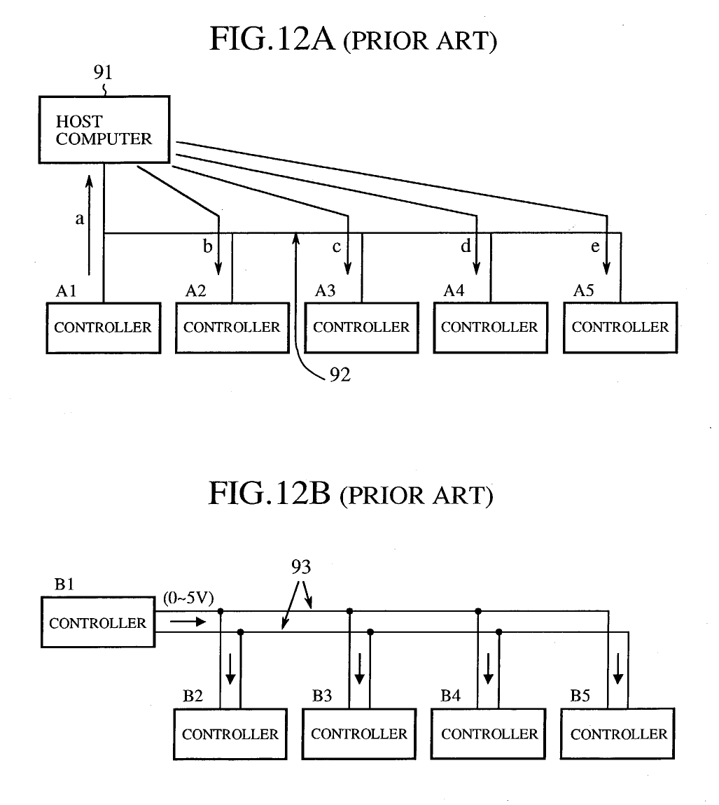

Throughout the figures, the same reference numerals, and characters, unless otherwise noted, are used to denote like features, elements, components, or portions of the illustrated embodiment.

### DESCRIPTION OF THE PREFERRED EMBODIMENTS

The preferred embodiments of the present invention will be described in details with reference to the attached drawings.

### First Embodiment

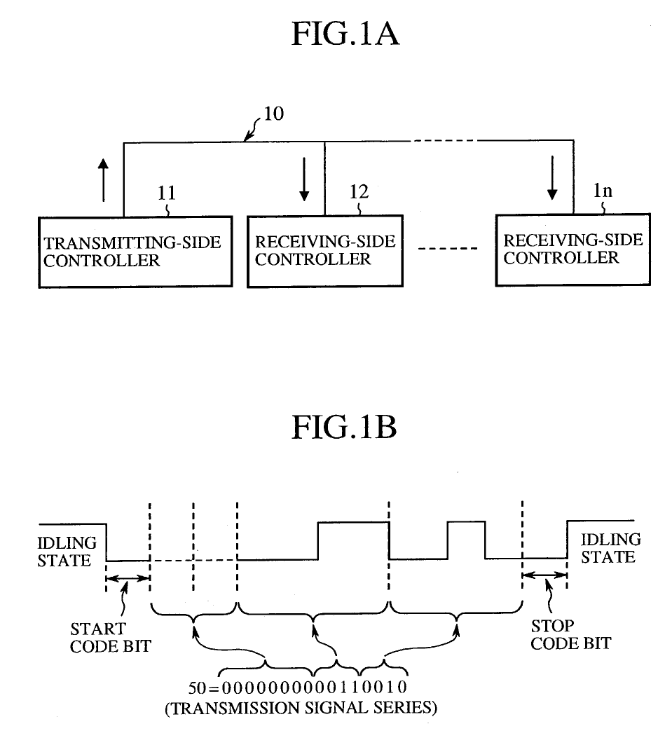

FIG. 1 is an explanatory drawing showing the principle of a control system for controlled variables of the first embodiment.

FIG. 1B shows signal waves of digital information where a transmitting-side controller 11 transmits a numerical value “50” as control information (transmission data) to the receiving-side controllers 12 to in, and binary data (transmission signal series) corresponding thereto.

Referring to FIG. 1A, the transmitting-side controller 11 converts predetermined control information (transmission data signal) indicative of controlled variables, a manipulation method, and various instructions into digital information (binary data), and serially transmits this binary data signal through a signal line 10 from a DO terminal (not shown).

Receiving-side controllers 12 to 1n input the transmitted signal to the DI terminal through the signal line 10 and store it in a memory after having converted into received data.

In FIG. 1B, an idling state, a start code bit, and a stop bit will be described in detail later.

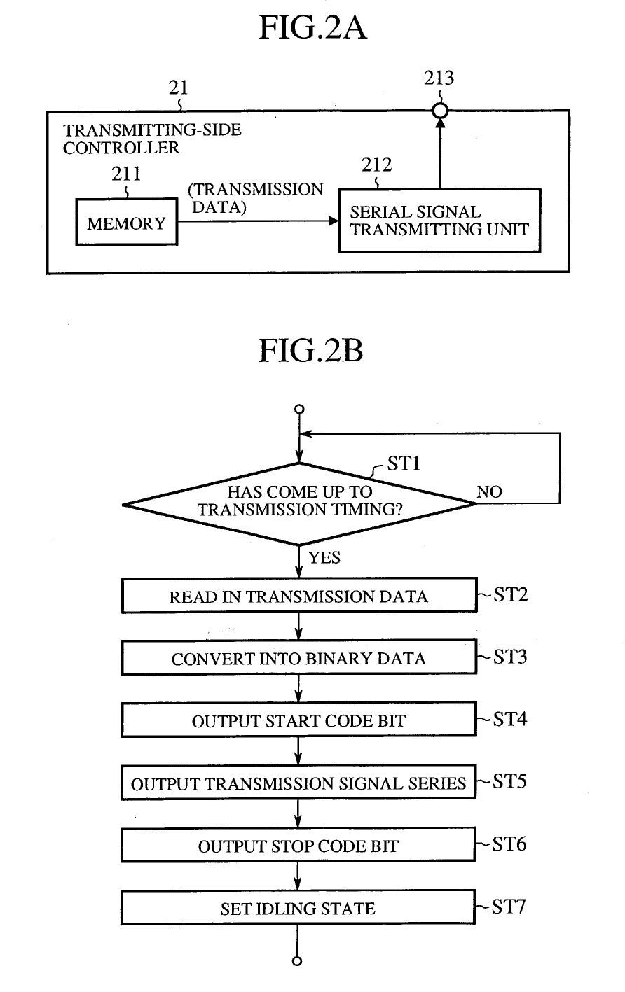

FIG. 2 is a block diagram showing a configuration of the transmitting-side controller for controlled variables of the first embodiment, and a flow chart showing its operations.

FIG. 2A is a block diagram showing a configuration of the transmitting-side controller for controlling controlled variables of the first embodiment. FIG. 2B is a flow chart showing operations of the transmitting-side controller.

Referring to FIG. 2A, reference numeral 21 denotes a transmitting-side controller, 211 denotes a memory in which transmission data in an internal form consisting of the predetermined control information indicative of controlled variables, a manipulation method, and various instructions are stored, 212 denotes a serial signal transmitting unit (serial signal transmitting means) for converting the transmission data into serial binary data and transmitting the converted data, 213 denotes a DO terminal for outputting to the outside the transmission data from the serial signal transmitting unit 212.

Hereupon, suppose the DO terminal 213 can be connected to the communication line.

The operation of the serial signal transmitting unit 212 in the transmitting-side controller 21 shown in FIG. 2A will then be described with reference to the flow chart shown in FIG. 2B.

First, the serial signal transmitting unit 212 judges whether or not the present time has already come up to a predetermined transmission timing. If the present timing has not yet come up to the predetermined transmission timing, the unit 212 waits until the present timing comes up to the predetermined transmission timing, during which an idling state is outputted, otherwise the unit 212 proceeds to step ST 2 (step ST 1). Hereupon, suppose this predetermined transmission timing can be previously determined as a given period starting from the predetermined time, and it is possible to substitute a predetermined sign given by a user for the predetermined transmission timing.

Subsequently, the serial signal transmitting unit 212 reads out transmission data, or predetermined control information indicative of controlled variables, a manipulation method, and various instructions, from the memory 211 (step ST 2), and converts the transmission data into serial binary data as shown in FIG. 1B (step ST 3). After that, the unit 212 outputs as a header of the transmission data a given start code bit (step ST 4), and outputs transmission signal series, or serial binary data obtained by the above conversion (step ST 5).

Finally, the unit 212 outputs as a footer of the transmission data a given stop code bit (step ST 6), and waits until the next transmission timing starts, during which an idling state is outputted (step ST 6).

As mentioned above, according to the first embodiment, it provides the controller for controlled variables able to output at a predetermined timing transmission data, or the predetermined control information indicative of controlled variables, a manipulation method, and various instructions from the transmitting-side controller to the DI terminal connected to the communication line.

### Second Embodiment

The second embodiment is subject to the same principle as the first embodiment.

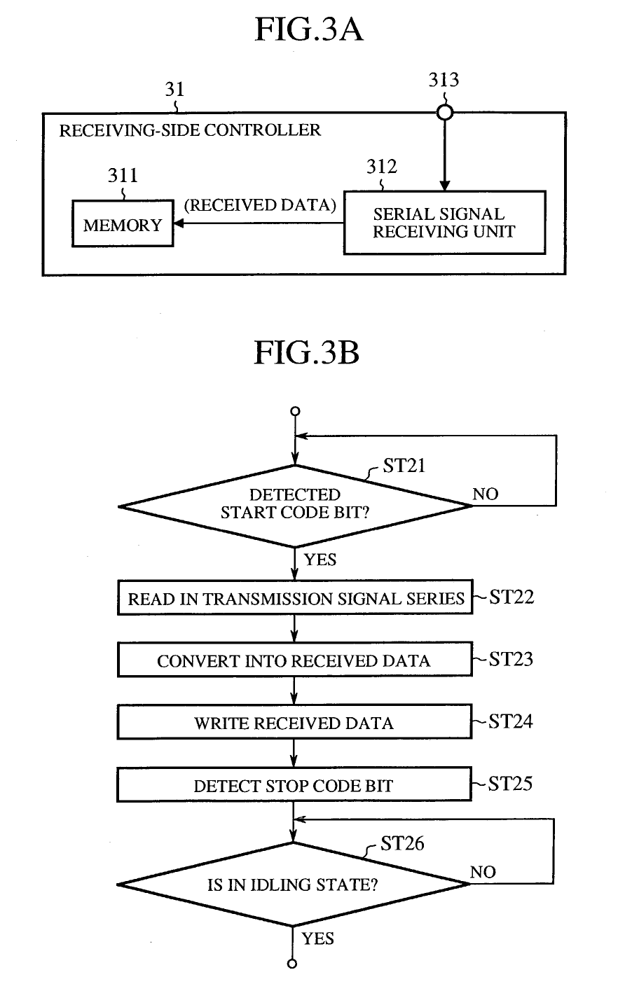

FIG. 3 is a block diagram showing a configuration of the receiving-side controller for controlled variables of the second embodiment, and a flow chart showing its operations.

FIG. 3A is a block diagram showing a configuration of the receiving-side controller for controlling controlled variables of the second embodiment. FIG. 2B is a flow chart showing operations of the receiving-side controller.

Referring to FIG. 3A, reference numeral 31 denotes a transmitting-side controller, 311 denotes a memory in which control information (received data) is stored, 312 denotes a serial signal receiving unit (serial signal receiving means) for receiving serial binary data, and for converting the received binary data into received data in an internal form, 313 denotes a DI terminal for receiving serial binary data, and for feeding the received binary data to the serial signal receiving unit 312.

Hereupon, suppose the DI terminal 313 can be connected to the communication line.

The operation of the serial signal receiving unit 312 in the receiving-side controller 31 shown in FIG. 3A will then be described with reference to the flow chart shown in FIG. 2B.

First, the serial signal receiving unit 812 judges whether or not a start code bit is contained in the received signal data. If the start bit code is not contained in the received signal data, then the unit 312 waits until the start code bit detects, otherwise the unit 312 proceeds to step ST 22 (step ST 21).

Subsequently, the unit 312 continually reads in received signal series, or the received serial binary data from the received signal (step ST 22), and converts the serial binary data into received data in an internal form (step ST 23). The received data is in turn stored in the memory 311 (step ST 24). The received data stored in the memory 311 is used as control information for controlling a device that is under the control of the receiving-side controller 31.

Finally, the unit 312 detects a stop code bit from the above received signal (step ST 25) and judges whether or not the received signal is in an idling state. If the received signal is not in the idling state, then the unit 312 waits until the received signal comes to the idling state, otherwise the unit 312 terminates this processing (step ST 26).

As mentioned above, according to the second embodiment, it provides the controller for controlled variables able to use the received data, or the predetermined control information inclusive of controlled variables, a manipulation method, and various instructions, inputted to the DI terminal connected to the communication terminal, as if it were the control information for controlling the controlled device that is under the control of the receiving-side controller 31.

### Third Embodiment

The third embodiment is subject to the same principle as the first embodiment.

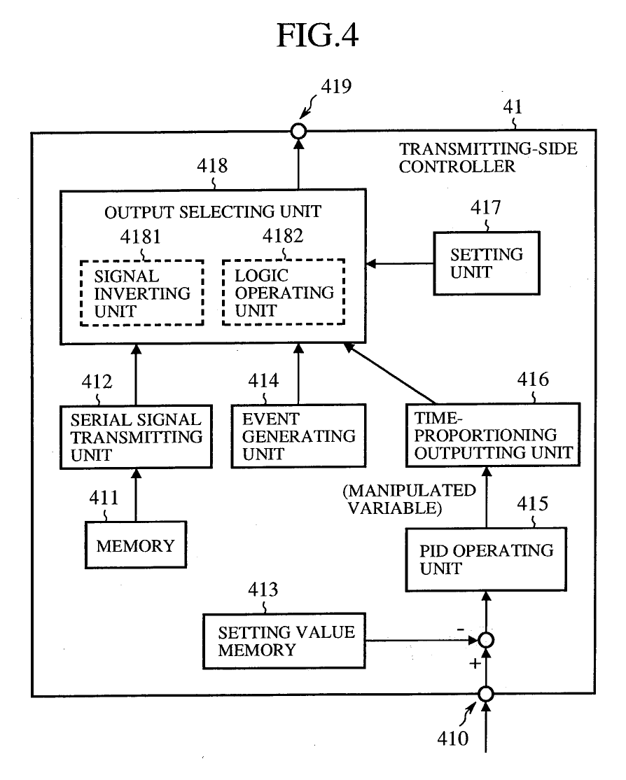

FIG. 4 is a block diagram showing a configuration of the transmitting side controller for controlled variables of the third embodiment.

Referring to FIG. 4, reference numeral 41 denotes a transmitting-side controller, 411 denotes a memory in which transmission data in an internal form consisting of the control information indicative of controlled variables, a manipulation method, and various instructions are stored, 412 denotes a serial signal transmitting unit (serial signal transmitting means) for converting the transmission data into serial binary data, and for transmitting the converted binary data, 413 denotes a setting value memory in which a given setting value for controlling the measured value fed from the controlled device (not shown) to a measured value input terminal 410 are stored, 414 denotes event generating unit (event generating means) for detecting and notifying generation of an event, 415 denotes a PID operating unit (PID operating means) for controlling the controlled device by proportional plus integral plus derivative action, 416 denotes a time-proportioning outputting unit (time-proportioning outputting means) for converting the magnitude of an output of the PID operating unit into a specific ON/OFF signal for switching a switch in the controlled device in accordance with the controlled variables, 417 denotes a setting unit for setting configurations, functions, and operations of an output selecting unit described later, 418 denotes an output selecting unit (output selecting means) for selecting and outputting each output of the serial signal transmitting unit 412, the event generating unit 414, and the time-proportioning outputting unit 416, 4181 denotes a signal inverting unit for inverting a signal by the output selecting unit 418, 4182 denotes a logic operating unit for executing a logic operation of a signal by the output selecting unit 413, 419 denotes a DO terminal for outputting an output selected by the output selecting unit 418 to the outside.

Hereupon, suppose the Do terminal 419 can be connected to the communication line, and the memory 411, serial signal transmitting unit 412, and the event generating unit 414 are not compulsory and thus may be omitted.

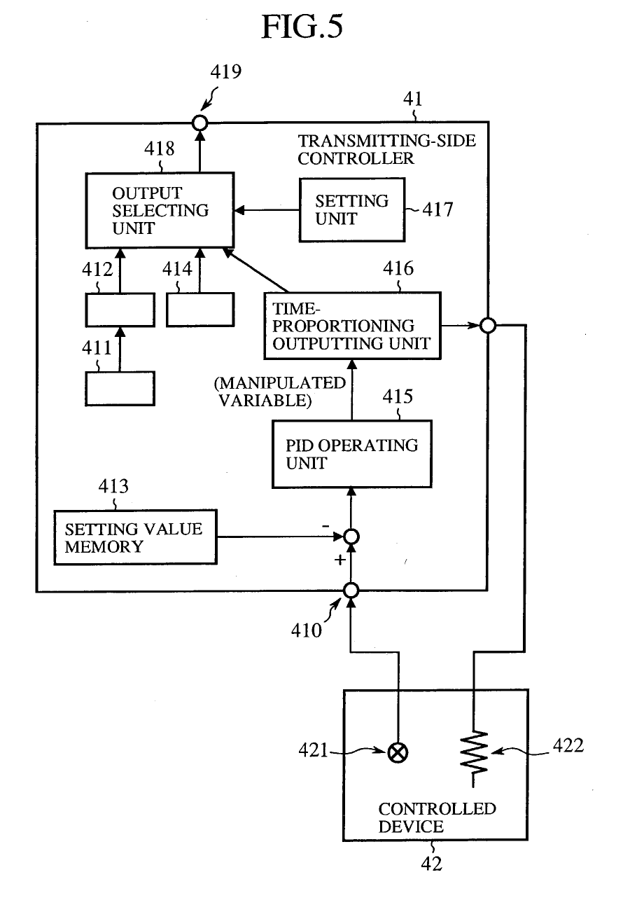

FIG. 5 is a block diagram showing a system in which the controller for controlled variables shown in FIG. 4 is applied to a specific controlled device.

Referring to FIG. 5, reference numeral 42 denotes a controlled device, 421 denotes a temperature sensor, 422 denotes a heater.

The operation of the controller for controlled variables of the third embodiment will now be described.

The operations and functions of the memory 411 and the serial signal transmitting unit 412 are the same as those of the first embodiment.

The event generating unit 414 judges whether or not the state of the system at the present including the controlled device meets the predetermined condition. If the state of the system meets the predetermined condition, then a given event notifying signal in correlation with the predetermined condition is outputted.

The measured value input terminal 410 inputs the measured value, or temperature measured by the temperature sensor 421 obtained by measuring a condition of the controlled device 42.

The setting value memory 413 keeps a given setting value storing therein that is to be subtracted from the measured value.

The PID operating unit 415 inputs a value obtained by subtracting (with measured value controlling means) the setting value stored in the setting value memory 413 from the measured value, and outputs controlled variable information for controlling the controlled device by proportional plus integral plus derivative action.

The time-proportioning outputting unit 416 converts as a specific control signal corresponding to the controlled variable information, or the magnitude of an output of the PID operating unit 415, this controlled variable information into an ON/OFF signal for switching an ON/OFF state of a switch of the device (heater 422) in the controlled device in accordance with the controlled variables, and outputs the ON/OFF signal to the heater 422 (a switch thereof is not shown) and to the output selecting unit 418.

The setting unit 417 includes a memory (not shown), from which information is read out in order to set configurations, functions, and operations of the output selecting unit 418.

The output selecting unit 418 simultaneously inputs the serial binary data from the serial signal transmitting unit 412, the event notifying information from the event generating unit 414, and an ON/OFF signal from the time-proportioning outputting unit 416, selects these inputs in accordance with the configurations, the functions, and the operations set by the setting unit 417, and feeds the selected input to the DO terminal 419. At this moment, the signal inverting unit 4181 for inverting polarity of a signal and the logic operating unit 4182 for executing a logic operation of a signal are adopted in order to implement the above configurations, the functions, and the operations.

As mentioned above, according to the third embodiment, it provides the controller for controlled variables able to feed to the DO terminal connected to the communication line control information actually used when controlling the controlled device that is under the control of the transmitting-side controller 41 by proportional plus integral plus derivative action.

Moreover, it provides the controller for controlled variables able to feed to the DO terminal connected to the communication line the control information consisting of the serial binary data as with the first embodiment, and an event notifying signal for notifying the present state of the system inclusive of the controlled device.

### Fourth Embodiment

The fourth embodiment is subject to the same principle as the first embodiment.

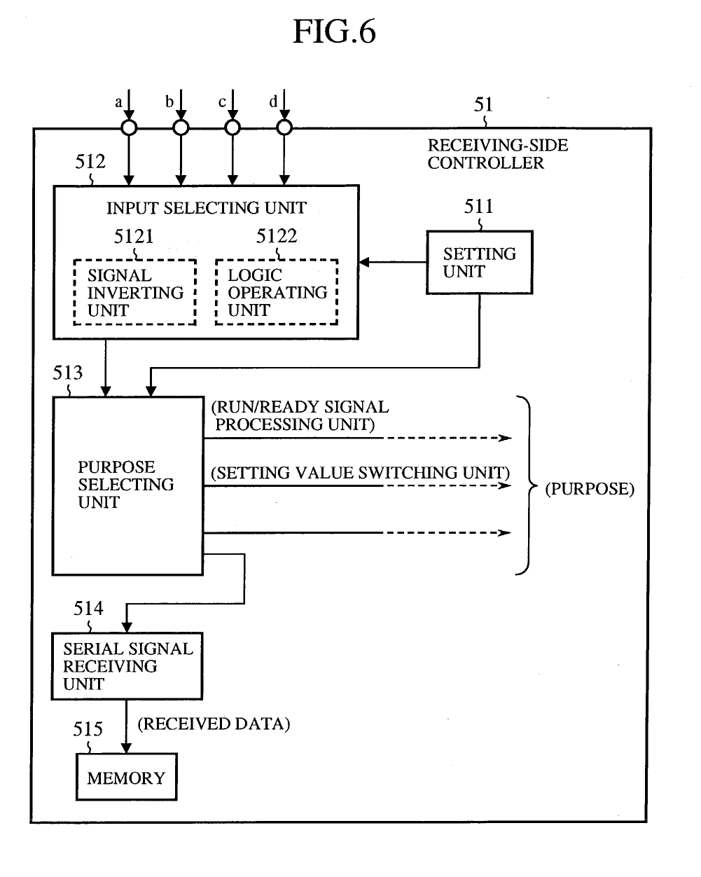

FIG. 6 is a block diagram for showing a configuration of the receiving-side controller for controlled variables.

Referring to FIG. 6, reference numeral 51 denotes a receiving-side controller, 511 denotes a setting unit for setting configurations, functions, operations of an input selecting unit described later, 512 denotes an input selecting unit (input selecting means) for selectively inputting a plurality of input information, 513 denotes a purpose selecting unit (purpose selecting means) for outputting the input information by given purposes, 514 denotes a serial signal receiving unit (serial signal receiving means) for converting input information, the received signal inclusive of the serial binary data, or the ON/OFF signal, into the received data in an internal form, 515 denotes a memory in which the received data, or control information indicative of controlled variables, a manipulation method, and the various instructions obtained by the above conversion are stored.

The operation of the controller for controlled variables of the fourth embodiment will now be described.

The setting unit 511 includes a memory (not shown), from which the unit 511 reads out information in order to set configurations, functions, and operations of the input selecting unit 512.

The input selecting unit 512 selectively inputs the inputted plural control signals (input signals a, b, c, d) in accordance with the configurations, the functions, and the operations. At this time, the signal inverting unit 5121 for inverting polarity of a signal and the logic operating unit 5122 for executing a logic operation of a signal are adopted in order to implement the configurations, the functions, and the operations set by the setting unit 511.

The purpose selecting unit 513 converts the selectively inputted control signal into control data by given purposes, and outputs the converted data. At this moment, the control signal is converted into control data by given purposes at need. The data outputted from the purpose selecting unit 513 takes up various types, such as serial binary data, the predetermined control information indicative of the controlled variables, the manipulation method, and the various instructions, or the ON/OFF signal, a RUN/READY signal, a setting value switching signal. The serial binary data or the ON/OFF signal is fed to the serial signal receiving unit 514.

The serial signal receiving unit 514 receives serial binary data from the purpose selecting unit 513, converts the serial binary data into the received data in an internal form, and stores the received data in the memory 515.

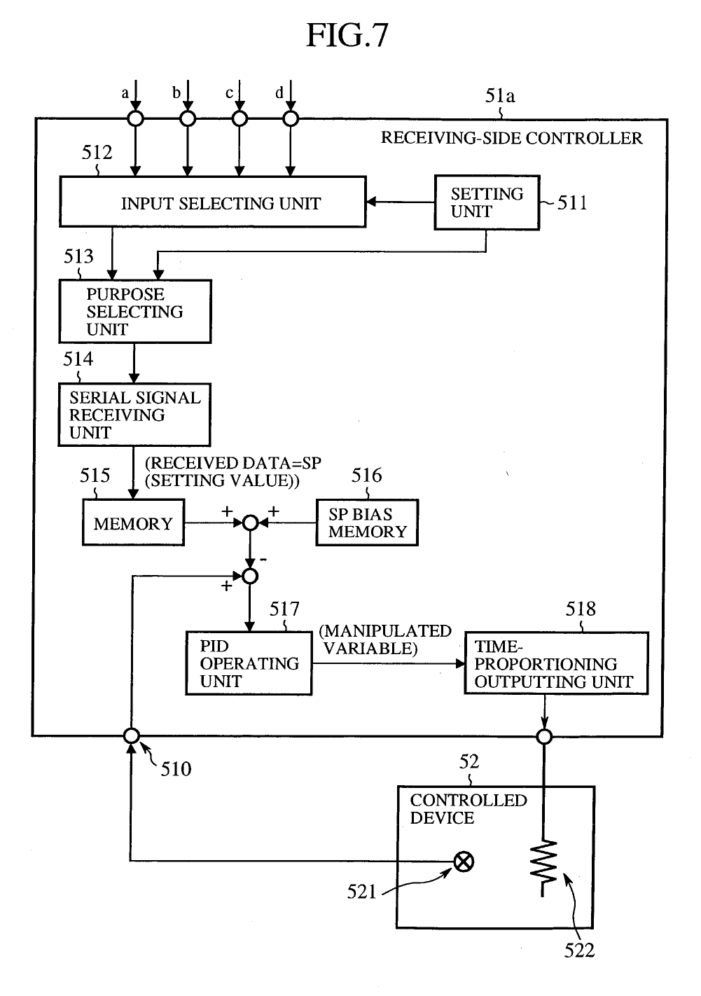

FIG. 7 is a block diagram showing a configuration in which the receiving-side controller for controlled variables shown in FIG. 6 is applied to a specific controlled device.

The system including the receiving-side controller 5a shown in FIG. 7 is the case where the received data (control information) stored in the memory 515 is used as a bias value for setting.

The control information, or the bias value for setting outputted from the purpose selecting unit 513 and stored in the memory 515 is added to a bias value for a setting value stored in the SP bias memory 516, and the measured value, or temperature measured by the temperature sensor 521 is subtracted from the added result. After that, the subtracted result is inputted to the PID operating unit 517.

The PID operating unit 517 inputs the above subtracted result and outputs control information (manipulated variable) for controlling the controlled device by proportional plus integral plus derivative action.

The time-proportioning outputting unit 518 converts as a specific control signal corresponding to this control information, or the magnitude of an output of the PID operating unit 517 the controlled variable information into a signal for switching an ON/OFF state of a switch of a device (heater 522) in the controlled device in accordance with the controlled variables, and feeds the converted signal to the heater 522 (a switch thereof is not shown).

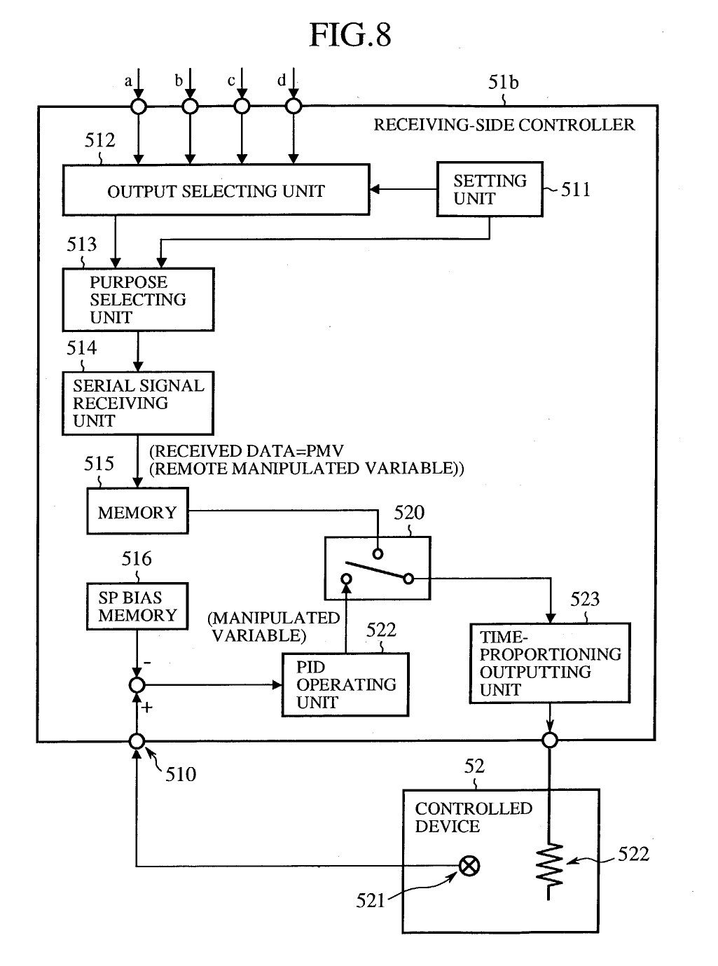

FIG. 8 is a block diagram showing another configuration in which the receiving-side controller for controlled variables is applied to a specific controlled device.

The system including the receiving-side controller 5b shown in FIG. 8 is the case where the received data (control information) stored in the memory 515 is used as a manipulated variable.

The control information (remote manipulated variable) outputted from the purpose selecting unit 513 and stored in the memory 515 is inputted to the time-proportioning outputting unit 523 through a switch 520.

Meanwhile, the manipulated variable for setting stored in the SP memory 516 are subtracted from the measured value, or temperature measured by the temperature sensor 521 fed to the measured value terminal 510, and the subtracted result is inputted to the PID operating unit 522. The PID operating unit 522 finds control information (manipulated variable) for controlling the controlled device by proportional plus integral plus derivative action, and outputs the control information to the time-proportioning outputting unit 523 through the switch 520.

The time-proportioning outputting unit 523 calculates an actual controlled variable from the above both control information (manipulated variable), converts the calculated controlled variable into a signal for switching an ON/OFF state of the switch of the device (heater 522) in the controlled device in accordance with the controlled variables, and feeds the converted signal to the heater 522 (a switch thereof is not shown).

As mentioned above, according to the fifth embodiment, it provides the controller for controlled variables able to select a control signal received from the plural paths on the basis of the predetermined configuration, the functions, the operations of the output selecting unit, and for outputting the selected control signal by purposes or after applying a conversion thereto, if necessary.

Moreover, it provides the controller for controlled variables able to control the controlled device that is under the control of the receiving-side controller 51 by proportional plus integral plus derivative action when a serial binary signal or an ON/OFF signal is received, as if the control information contained in these signals were the control information for controlling the controlled device that is under the control thereof.

### Fifth Embodiment

The fifth embodiment is subject to the same principle as the first embodiment.

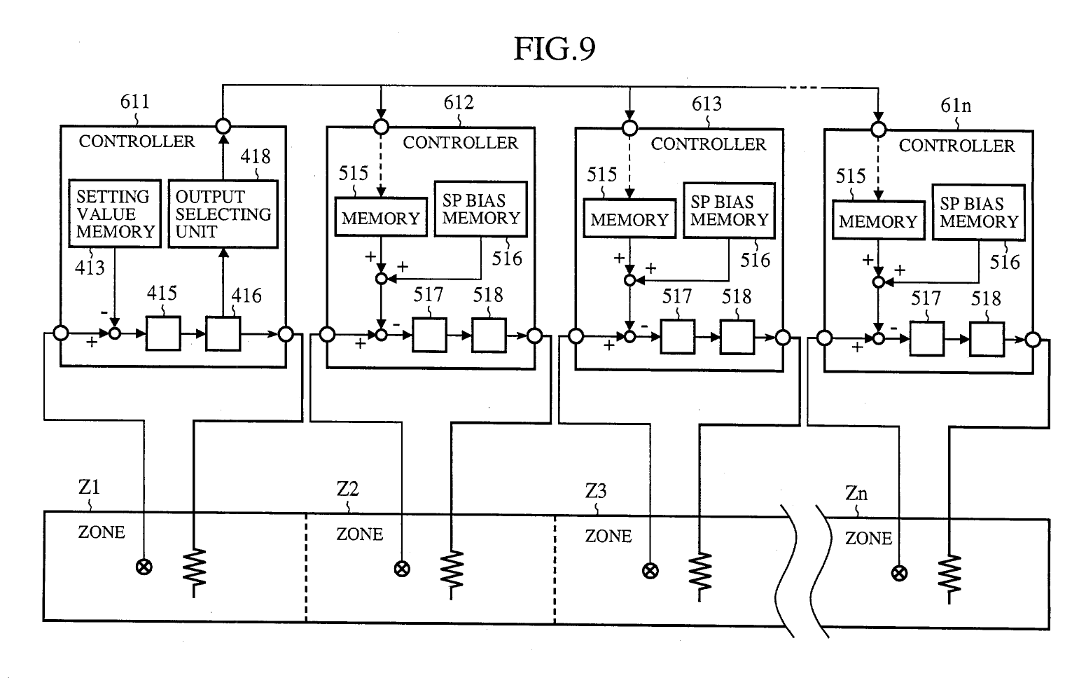

FIG. 9 is a block diagram showing a configuration of the control system for controlled variables of the fifth embodiment.

Referring to FIG. 9, reference numeral 611 denotes a transmitting-side controller, 612 to 61n denote receiving-side controllers, Z1 to Zn denote physically consecutive controlled devices that are under the control of the controllers 611 to 61n.

In FIG. 9, the controller 611 may have the same configuration as the transmitting-side controller 41 of the third embodiment shown in FIGS. 4, 5, and the controllers 612 to 61n as the receiving-side controller 5a of the third embodiment shown in FIG. 7.

The operation of the controller for controlled variables of the fifth embodiment will now be described.

The control system for controlled variables of the fifth embodiment controls the physically consecutive zones (Z1 to Zn) in a manner to maintain constant temperature.

The controller 1 transmits a difference (setting value) of temperature to be set to the controllers 612 to 61n.

The controllers 612 to 61n add a bias value of the setting value stored in the SP bias memory 516 in accordance with characteristics of the zones Z2 to Zn to the value (setting value) of the transmitted temperature to be set, subtract the value obtained by measuring zones Z2 to Zn from the added result, and input the subtracted result to the PID operating unit 517. The time-proportioning outputting unit 518 converts the subtracted result into an ON/OFF signal, and transmits it to the zones Z3 to Zn. This controls the zones Z2 to Zn by proportional plus integral plus derivative action so as to be the same temperature as the zone Z1.

As mentioned above, according to the fifth embodiment, it controls uniformly the plural physically consecutive zones by proportional plus integral plus derivative action.

### Sixth Embodiment

The sixth embodiment is subject to the same principle as the first embodiment.

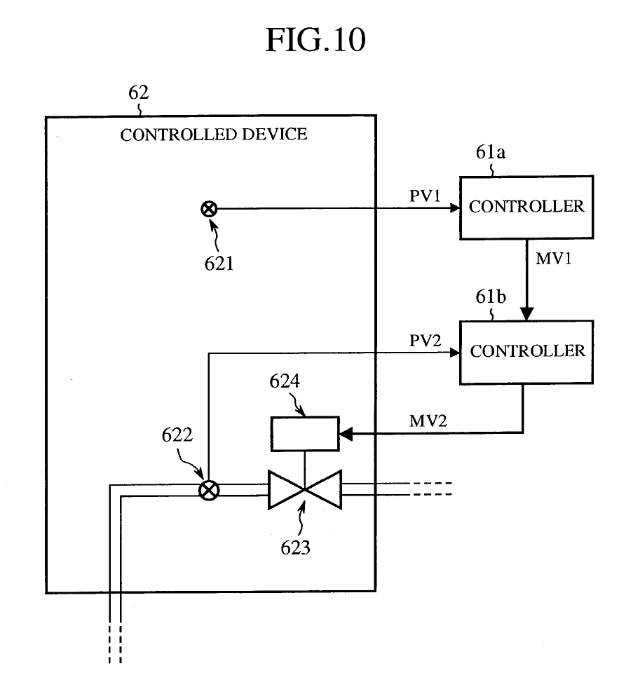

FIG. 10 is a block diagram showing a schematic configuration of the control system for controlled variables of the sixth embodiment.

Referring to FIG. 10, reference numeral 61a denotes a transmitting-side controller, 61b denotes a receiving-side controller, 62 denotes a controlled device, 621 denotes a temperature sensor, 622 denotes a flow sensor, 623 denotes a valve body, 624 denotes a valve of the valve body 623, PV1 denotes temperature measured by the temperature sensor 621 in the controlled device 62, PV2 denotes a flow measured by the flow sensor 622 in the controlled device 62, MV1 denotes a manipulated variable (setting value) that the controller 61a instructs to the controller 61b, MV2 denotes valve opening instructions for opening the valve 624 of the valve body 623.

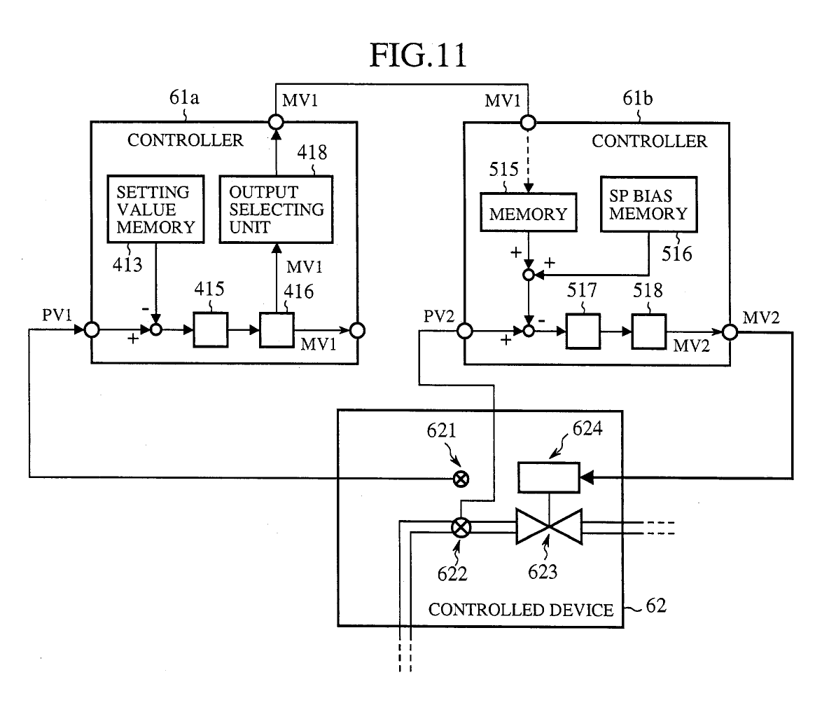

FIG. 11 is a block diagram showing a specific configuration of the control system for controlled variables shown in FIG. 10.

In FIG. 11, the transmitting-side controller 61a may have the same configuration as the transmitting-side controller 41 shown in FIG. 5 of the second embodiment, and the receiving-side controller 61a as the receiving-side controller 5a shown in FIG. 7 of the second embodiment.

The control system for controlled variables shown in FIGS. 10, 11 control a flow (second physical variable) of the valve 623 on the basis of internal temperature (first physical variable) obtained by measuring the controlled device 62, and the flow of the valve 623 is controlled by proportional plus integral plus derivative action.

As mentioned above, according to the sixth embodiment, it permits control of the second physical variable (e.g., flow of the valve) by the first physical variable (e.g., internal temperature) obtained by measuring the controlled device by proportional plus integral plus derivative action.

In passing, programs for commanding processing devices to execute the above processing, such as a program for executing processing as shown in the flow chart in FIGS. 2A, 2B may be stored and distributed through computer readable memory mediums, such as a semiconductor memory, a CD-ROM, a magnetic tape. Besides, any computers, including a micro computer, a personal computer, a general purpose computer may be read out from the above computer readable memory mediums and executed them.

While, in the above prior arts and preferred embodiments of the invention, the controller for controlled variables and the control system for the same are given as an example, it should be understood by those skilled in the art that various modifications and changes may be made without departing from the sprit and scope of the invention.

Also, it should be noted that the invention meets all the objects mentioned above and also has the advantages of wide commercial utility, and that the invention has been set forth for purposes of illustration only and not of limitation. That is, the invention is limited only by the following claims which follow. Consequently, reference should be made to the following claims in determining the full scope of the invention.

What is claimed is:

1. A controller for controlled variables for transmitting control information to a receiving-side controller connected to a communication line, comprising serial signal transmitting means for converting transmission data in an internal form inclusive of control information read out from a memory into serial binary data, and for outputting the converted data to a DO terminal after having produced a transmission signal inclusive of said binary data.

2. A controller for controlled variables for receiving control information from a transmitting-side controller connected to a communication line, comprising serial signal receiving means for converting serial binary data contained in received signal inputted to a DI terminal into received data in an internal form, and for writing the converted data in a memory.

3. A controller for controlled variables for, when a receiving-side controller controls a controlled device that is under the control thereof, transmitting control information required to said receiving-side controller connected to a communication line, comprising:
output selecting means for selecting a plurality of output signals by previously established algorithm, and for outputting the selected output signals;
measured value controlling means for controlling a measured value of a given physical variable obtained by measuring the controlled device that is under the control thereof on the basis of the given setting value;
PID operating means for executing an operation for controlling said controlled device by proportional plus integral plus derivative action using an output from said measured value controlling means, and for outputting the executed result as a manipulated variable;
time-proportioning outputting means for inputting the manipulated variable outputted from said PID operating means, converting it to an ON/OFF signal required when manipulating a switch in the controlled device by said receiving-side controller through said receiving-side controller, and feeding said ON/OFF signal as an output signal to the controlled device that is under the control thereof, and to said output selecting means.

4. The controller for controlled variables according to claim 3, wherein serial signal transmitting means is additionally provided for converting the transmission data in an internal form inclusive of the control information read out from a memory, and for outputting the converted data as an output signal to said output selecting means after having produced a transmission signal inclusive of said binary data.

5. The controller for controlled variables according to claim 3, wherein event generating means is additionally provided for outputting a given event notifying signal as an output signal in correlation with a predetermined condition to said output selecting means when the state of the system inclusive of the controlled device meets the predetermined condition.

6. A controller for controlled variables for controlling a controlled device on the basis of control information of the plural systems received from a receiving-side controller connected to a communication line, comprising:
input selecting means for selecting and outputting said control information of the plural systems;
purpose selecting means for distributing said selected control signal depending on its purpose;
serial data receiving means for converting serial binary data or an ON/OFF signal contained in one output from said purpose selecting means into received data in an internal form, and writing the converted data in a memory.

7. The controller for controlled variables according to claim 6, wherein said received data indicates a setting value of the controlled variables for controlling the controlled device.

8. The controller for controlled variables according to claim 6, wherein said received data indicates a remote manipulated variable for controlling the controlled device.

9. A control system including a transmitting-side controller connected to a communication line and a plurality of receiving-side controllers for receiving control information from said transmitting-side controller;
wherein said transmitting-side controller comprises means for controlling one section of a common controlled device, and for transmitting the control information used for control to each of the plurality of receiving-side controllers; and
wherein said each of the plurality of receiving-side controller comprises means for controlling each section of said common controlled device in correlation with each of the plurality of receiving-side controllers except said one section on the basis of the control information transmitted form the transmitting-side controller.

10. A control system for controlled variables including a transmitting-side controller connected to a communication line and a receiving-side controller for receiving control information from said transmitting-side controller;
wherein said transmitting-side controller comprises means for transmitting a first physical variable obtained by measuring a common controlled device to said receiving-side controller; and
wherein said receiving-side controller controls a second physical variable of said common controlled device on the basis of said first physical variable transmitted from said transmitting-side controller.
